(19) United States
(12) Patent Application Publication
(10) Pub. No.: US 2002/0010764 A1
(43) Pub. Date: Jan. 24, 2002

(54) Method, apparatus, and system for centrally defining and distributing connection definitions over a network

(76) Inventor: David A. Spicer, Suwanee, GA (US)

Correspondence Address: Gregory J. Kirsch, Esq., NEEDLE & ROSENBERG, P.C., The Candler Building, 127 Peachtree Street, N.E., Suite 1200, Atlanta, GA, 30303-1811, US

(21) Appl. No.: 09/896,553

(22) Filed: Jun. 29, 2001

Related U.S. Application Data
(60) Provisional application No. 60/215,336, filed on Jun. 30, 2000.

(51) Int. Cl. G06F 15/177

(52) U.S. Cl. 709/220

(57) ABSTRACT

Connection definitions are centrally defined and distributed over a network. A connection is defined, including information identifying an associated service definition, an associated origination endpoint and an associated destination endpoint within the network. The connection definition is distributed via the network to the origination endpoint and the destination endpoint. The service defined by the service definition is implemented between the origination endpoint and the destination endpoint, and the origination endpoint and the destination endpoint communicate with each other directly over the network in a secure and reliable way.

### CROSS REFERENCE TO RELATED APPLICATIONS

This application is related to U.S. Provisional Application No. 60/215,336 filed on Jun. 30, 2000 and hereby incorporated by reference.

### BACKGROUND OF THE INVENTION

The present invention is directed to a method and system for defining and distributing connection definitions. More particularly, the present invention is directed to a method and system for defining and distributing connection definitions from a central server to endpoints on a network.

The Internet enables information and services to be made widely available. In many cases, Internet users are willing to pay for the use of such information or services. Also, Internet users are increasingly purchasing goods over the Internet. Thus, with the growth of the Internet, an electronic commerce (e-commerce) market has emerged.

To maximize the market that sellers can reach, the sellers' web pages must be understood by different users' web browsers. To enable web pages to be understood by different web users using different web browsers, website developers use standard markup languages to describe the web pages. Ideally, the markup language identifies the structures in a web page in a way that may be interpreted by any web browser.

Today, service providers construct web pages using the HyperText Markup Language (HTML). HTML is a collection of tags that may be used to format a document, permitting web developers to describe how a document should look to a user. HTML is well suited to allowing interaction between human users and service provider machines.

However, as e-commerce evolves and becomes more complex, so does the need for machine-to-machine communication. For example, during an e-commerce transaction involving credit payment, one machine may need to communicate with another to obtain credit verification. In many cases, it would be advantageous to allow other machines to access services provided by a service provider, rather than human users.

HTML has a fixed tag set and fixed tag semantics and is thus is ill suited for machine-to-machine communications. Machines communicating with each other are primarily interested in the content of a document, not how the document is formatted. Since page content varies widely among web pages, it is not practical to have fixed sets of tags for representing content.

To enable efficient machine-to-machine communication, the Extensible Markup Language (XML), which specifies neither semantics nor a tag set, is being developed. XML provides a facility for defining tags and the structural relationships between them. Thus, XML enables web developers to create their own tag sets in documents that may be understood by any web browser. Thus, machines communicating with each other do not have to deal with formatting tags to determine the content in a document.

Today, many companies are working to define documents to exchange in XML format. These documents describe what information will be exchanged but not how the information is to be exchanged. The techniques that have been proposed thus far for distributing XML documents involve secure private networks between users and service providers. The manner in which XML documents may be disseminated widely across an insecure public network, such as the Internet, has not been addressed.

There is thus a need for a way of exchanging documents between machines in a efficient manner that is secure and reliable.

### SUMMARY OF THE INVENTION

The present invention is directed to a method, apparatus and system for centrally defining and distributing connection definitions over a network.

According to exemplary embodiments, a connection is defined, including information identifying an associated service definition, an associated origination endpoint and an associated destination endpoint within the network. The service definition includes a service name, associated inputs, and associated outputs. Each input or output may be a simple value, an XML document, or any arbitrary binary object.

The connection is defined by a service publisher at the origination endpoint or the destination endpoint publishing the service definition and inviting participation in the connection for implementing the service from a service subscriber at the other endpoint, and the service subscriber at the other endpoint accepting the invitation to participate. The connection definition is distributed via the network to the origination endpoint and the destination endpoint. An endpoint may be used as an origination endpoint, a destination endpoint, or both simultaneously. An endpoint may be involved in as many simultaneous connections as its processing environment will support.

The service defined by the service definition is implemented between the origination endpoint and the destination endpoint, and the origination endpoint and the destination endpoint communicate with each other directly over the network in a secure and reliable way.

According to exemplary embodiments, the connection definition may be updated and the updated connection definition may be distributed to the endpoints via the network. The information identifying the origination endpoint, the destination endpoint, or both may be updated. Also, the service defined by the service definition may be updated.

According to exemplary embodiments, the distribution of connection definitions is managed by initially distributing management information to at least one endpoint for managing the definition of connections and the distribution of connection definitions. The management information is also distributed to the other endpoint at the same time or at a later time. The management information may be updated, and the updated management information may be distributed to the endpoints.

The present invention provides authenticated/reliable/secure machine-to-machine communication over the web to enable services to be provided and invoked using distributed XML technology.

Further objects, advantages and features of the present invention will become more apparent when reference is made to the following description taken in conjunction with the accompanying drawings.

### BRIEF DESCRIPTION OF THE DRAWINGS

FIG. 1 illustrates an exemplary system according to exemplary embodiments;

FIG. 2 illustrates an exemplary XML service specification;

FIGS. 3A and 3B illustrate an exemplary process for defining and distributing connection definitions, according to an exemplary embodiment; and

FIG. 4 illustrates an exemplary invocation of a service.

### DETAILED DESCRIPTION OF THE INVENTION

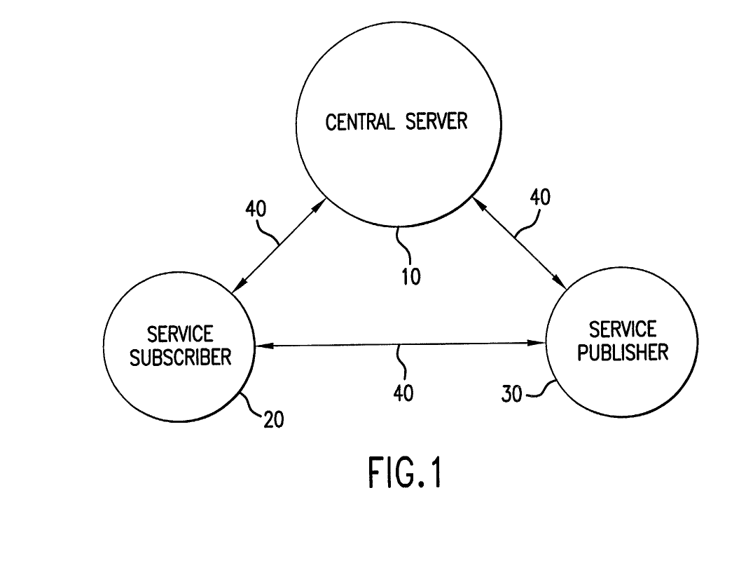

FIG. 1 illustrates an exemplary system for centrally defining and distributing connection definitions. The system includes a central server 10, one or more service subscribers 20, and one or more service publishers 30 connected by a network 40. Although only one service subscriber 20 and one service publisher 30 are shown in FIG. 1, it will be appreciated that the central server 10 may serve any number of service subscribers 20 and service publishers 30.

In the central server 10, service definitions, e.g., XML service specifications, are registered. In addition, distributed network software for distributing connection definitions, including service definitions and endpoint information, is stored and maintained. The distributed network software is downloaded from the central server to the service publisher 30 and the service subscriber 20, and the service subscriber 20 and the service publisher 30 then communicate with each other via the central server 10 to establish connection parameters. The central server 10 then downloads the distributed connection definitions to each endpoint participating in the connection.

The service subscriber 20 and service publisher 30 may be implemented on any type of web server, e.g., a mainframe, an AS 400, etc. The network 40 may be a public network, such as the Internet, or an internal network such as an Intranet, or a combination of both.

A service definition that is registered at the central server 10 may be defined by a name for the service, zero or more inputs to that service, and zero or more outputs that the service provides as a function of its inputs. A service definition may have multiple versions, each with a different syntax for the service definition, a different set of semantics for the service, or both.

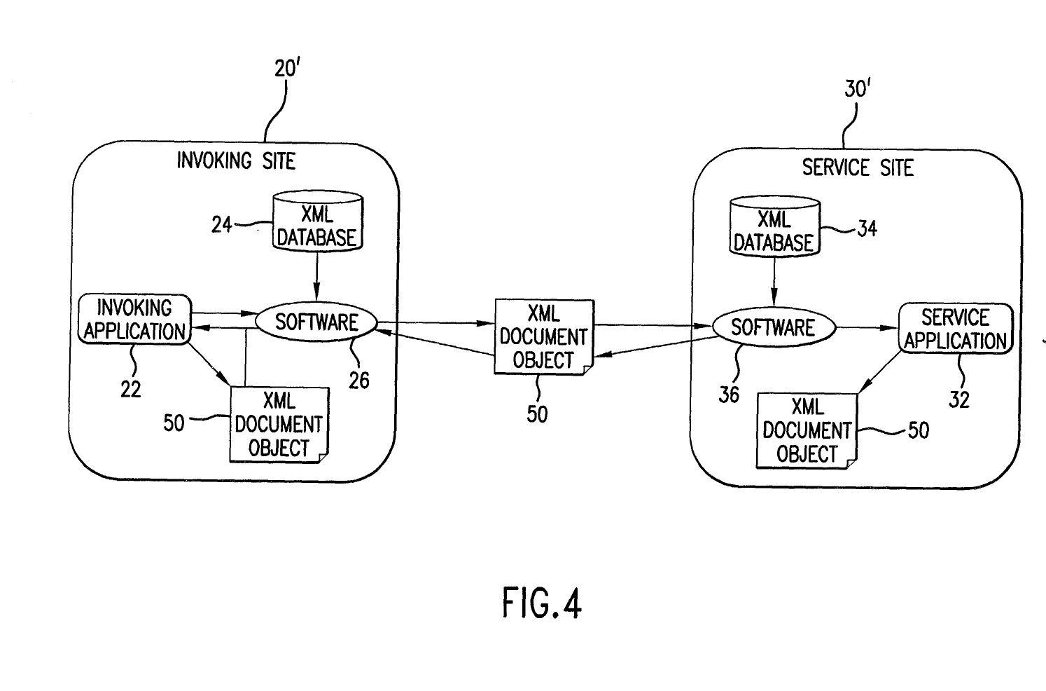

According to exemplary embodiments, a service is defined and registered centrally, and the service definition is distributed as part of a connection definition to both a service provider and any service caller that may wish to invoke that service. An exemplary invocation by a service caller of a service provided by a service provider is described in more detail below, with reference to FIG. 4. A new XML document type may be used for this purpose, serving initially as the central service definition, then being distributed to become the invoking document as well as the document that contains the responses from the invoked service.

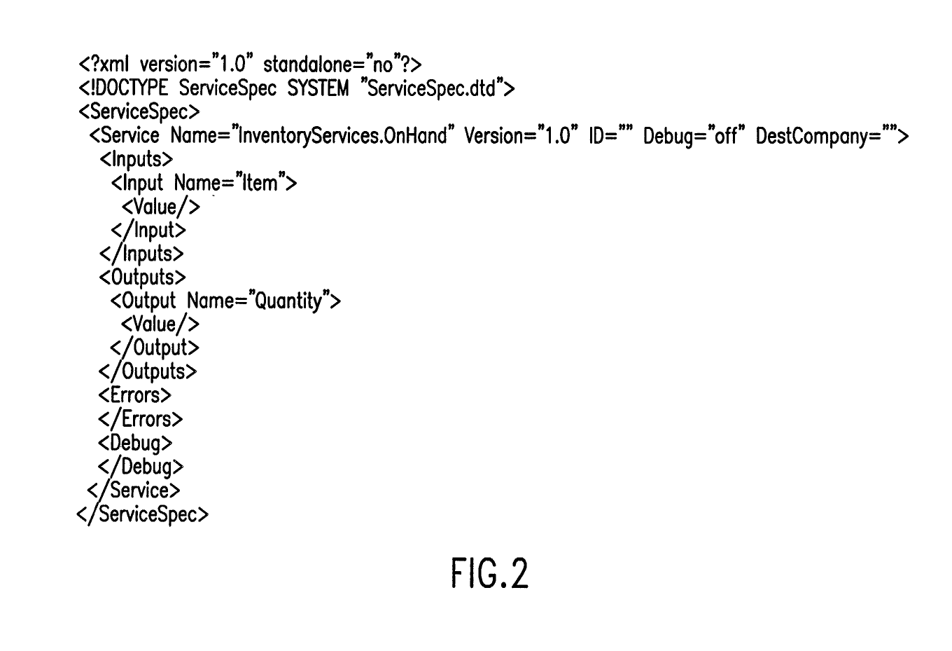

Once the distributed network software is downloaded from the central server 10 to the service publisher 30 and any potential service subscribers 20, the process of defining and distributing connections may begin. First, a service is defined by an author using, e.g., a template or service specification. FIG. 2 illustrates an exemplary XML service specification for defining a service called ‘InventoryServices.OnHand.’ The template includes standard tags for ‘Inputs,’ ‘Outputs,’ ‘Errors,’ and ‘Debug.’ Within the ‘Inputs’ and ‘Outputs’ tags, any number of tags may be defined that uniquely define the behavior of the service. In this example, the ‘InventoryServices.OnHand’ service defines one input called ‘Item’ and one output called ‘Quantity.’ Based on this definition, it is clear that the ‘InventoryServices.OnHand’ service requires an Item input to be filled in by a service caller with a service provider responding with the quantity of those items on hand in the Quantity field. The service provider may also respond with an error in the ‘Errors’ tag if the service caller were to specify an invalid item or if any other application error were to occur. Additionally, the distributed network software located at the service provider or service caller may provide error messages if an internal networking error were to occur.

Once a service is defined, a service author, which may be the service publisher 30, posts the service definition by storing this definition on the central server 10 to allow other potential publishers of services to see what services are available. Thus, the central server 10 acts as a digital marketplace for publishers and subscribers of XML-defined services. Publishers of service definitions may or may not be the authors of those definitions.

Authored definitions posted to the central server 10 are either public or private. Public definitions are available for other publishers to publish. Upon publishing the service definition, the service publisher 30 also indicates directionality of the service, i.e., whether the publisher's endpoint is the origination endpoint, the destination endpoint, or both for implementing the service defined by the service definition.

XML documents are inherently redundant with opening and closing tags. Once defined, for performance reasons, all service definitions are stored and transported in an object-oriented form as opposed to the native XML string format. This avoids redundancy for more efficient transport. The original string version of a service definition or any other XML document transported by the network may be reproduced from the object representation via a single method call.

After conversion to the object format, the XML definitions are stored at the central server 10 in a relational database, e.g., an Oracle database, for rapid access and distribution.

After the service definition is made available centrally, it is available to be referenced in a service connection between a service publisher 30 and a service subscriber 20. The service publisher 30 invites one or more subscribers 20 to participate in the connection and implement the service. This invitation may be extended via, for example, electronic mail from the service publisher 30 or via a message from the central server 10 on behalf of the publisher 30. When a service subscriber 20 accepts the invitation to implement the service, a copy of the service definition and connection information is distributed to the service publisher 30 and the service subscriber 20 endpoints. At the endpoints of the service publisher 30 and the service subscriber 20, the service definition and connection information are stored in a special purpose XML database that caches this information in memory for performance reasons, while simultaneously storing the information permanently on disk to persist this information between endpoint initializations. In this manner, XML documents may be centrally defined, distributed, and updated.

Rather than waiting on an invitation from a service publisher, a service subscriber may request a published service. For example, there may be services that are published for which an invitation is not required.

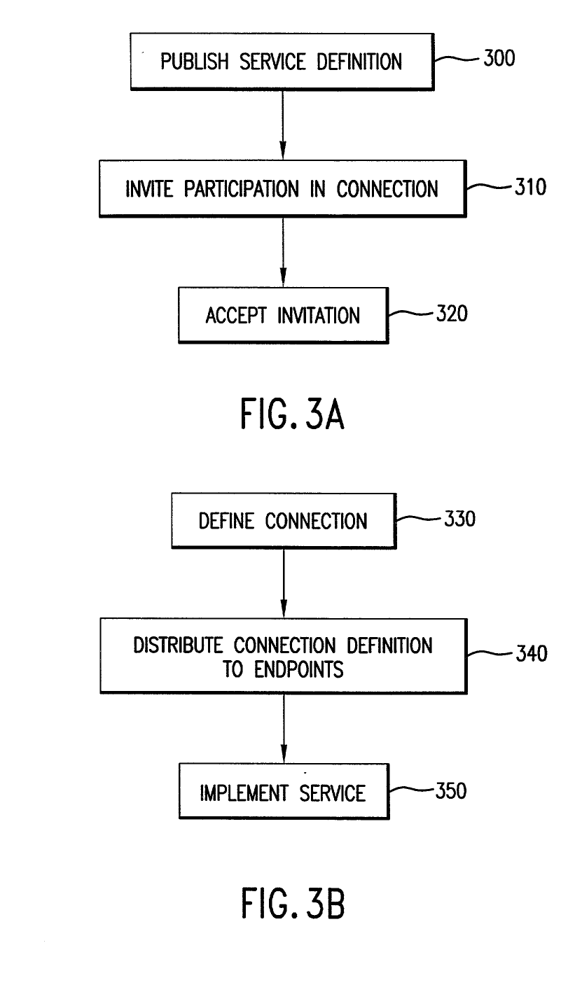

FIG. 3A illustrates a process for defining a connection. The process begins at step 300 at which a service definition is published by the service publisher 30. The service publisher 30 indicates directionality to the central server 10 by identifying itself as an origination endpoint, a destination endpoint, or both. The service publisher 30 also identifies one or more service subscribers 20 to be invited to participate in the service. At step 310, the service subscriber 20 is invited to participate in the connection for implementing the service. This invitation may be sent as an e-mail from the central server 10 on behalf of the publisher and contains a reference (URL) back to the central server 10 that the subscriber can use to establish their portion of the connection. At step 320, the invited subscriber 20 accepts the invitation to participate by responding to the inviting publisher via the central server 10 and indicating an endpoint that will participate in the connection. If the publisher's endpoint has been identified as the originating endpoint by the publisher 20, then the subscriber's endpoint will be the destination endpoint, and vice versa. Once the invitation is accepted, the connection is defined as including the service definition, the origination endpoint, and the destination endpoint.

FIG. 3B illustrates a process for distributing a connection definition. The process begins at step 330 by defining a connection, described in detail above. Next, at step 340, the connection definition is distributed via the network to the origination endpoint and the destination endpoint. At step 350, the service defined by the service definition is implemented between the origination endpoint and the destination endpoint, with the origination endpoint and the destination endpoint communicating directly with each other over the network.

Once the connection is defined, the central server 10 is not involved in the service implementation. The central server 10 may communicate with the service publisher 30 and the service subscriber 20 for other reasons, e.g., to provide updated information or to gather information. For example, the central server 10 may distribute updated service definitions or endpoint information to the service subscriber 20 and service publisher 30 at any time. If the server at one of the endpoints moves, this information is gathered by the central server 10 and distributed to the server at the other endpoints involved in the connection.

The central server 10 attempts to distribute changes to service and connection information at the time they occur to the endpoints involved in the changes. In some cases, the endpoints that need this information will not be available to receive it for reasons determined by the publisher or subscriber owners of these endpoints. In these cases, the central server 10 may wait until an endpoint contacts the central server 10 to distribute the updated information. For example, if an endpoint is not participating in a connection at the time of the update, the central server 10 will distribute the updated information to the endpoint upon the endpoint's next attempt to utilize that connection.

As referenced above, FIG. 4 illustrates in detail an exemplary communication between an invoking application and a receiving application once a connection has been defined. The invoking site is the service caller 20′, and the receiving (or service) site is the service provider 30′. The entity 30′ may be the same as the service publisher 30, but it is referred to in the context of a defined connection as a “provider”. Similarly, the entity 20′ may be the same as the service subscriber 20, but it is referred to in the context of a defined connection as a “caller”. For simplicity of explanation, in the following description the receiving site is the destination endpoint, and the invoking site is the origination endpoint.

To actually invoke the service, the invoking application 22 requests the service template or specification from the locally cached version in the special purpose XML database, specifying the destination endpoint. The invoking application 22 receives an instance of the empty XML service specification in object form 50 from the local XML database 24. The object 50 contains the name of the service and information identifying the service site. This XML document also contains instructions for filling in the service inputs by name as defined by the service publisher and validating that only defined inputs are provided. If all validations succeed, the original XML service specification is transformed into a carrier object 50 for the service request. If any validation fails, the XML service specification is returned to the service caller with appropriate error messages, and the carrier object is not sent.

Once all inputs have been specified, the carrier object 50 is sent as a service request to the service site. At the choice of the invoking application 22, service requests may be sent either synchronously, with the invoking site waiting for the response, or asynchronously, with the invoking site not needing to wait for the response. For ease of explanation, the remainder of this description assumes synchronous transmission.

Since the carrier object 50 has the name of the service and information identifying the service site stored internally, there is sufficient information to route this object directly to the destination endpoint without passing it through the central server. The carrier object 50 is transmitted to the service site over, for example, an HTTP connection.

Since the HTTP connection is not a highly reliable or secure connection, as the carrier object 50 is sent, it is encrypted, and the invoking site's digital certificate is attached to authenticate the user. In addition, a timer is started at the originating endpoint, and other protocol functionality is provided to ensure that the message is properly received at the destination.

To create a highly reliable network on top of the unreliable HTTP network, timeout/retransmission strategy with a sequence numbering algorithm may be used at the invoking site and the service site to guarantee one and only once receipt of the message without possibility of duplication.

At the destination endpoint, in this case the service site, using the information in the locally cached services and connections in the special purpose XML database 34, the received carrier object 50 is decrypted and compared with the XML definition for that service via the downloaded distributed network software 36 and the local special purpose XML database 34. The name of the service specified in the carrier object 50 is compared with the names of services provided at the destination endpoint, and digital signature comparison is performed between the attached originating endpoint certificate and all those that are allowed to use this service. If the name of the service specified in the carrier object does not exist or if the service does exist and there is a signature mismatch, the message is returned to the invoking site with an appropriate error message. If there is an exact match on the service name and signature, the service associated with this definition is invoked and can be implemented in any language. When the service is invoked, the service application 32 retrieves the inputs from the carrier object 50 using methods provided in the distributed software and performs the prescribed function for computing outputs. After all outputs have been computed, they are placed in the appropriate output tags in the carrier object 50 using methods provided in the distributed software. Then, the object is encrypted, the digital certificate of the service site is attached, and the encrypted object 50 is then returned to the invoking application 22.

At the invoking site, the returned carrier object 50 is decrypted and passed back to the invoking application for accessing the outputs. The distributed network software 26 checks the attached digital certificate of the destination endpoint to determine its authenticity. If there are any error messages in the returned carrier object 50, the object indicates to the invoking application that something has not worked correctly and provides a way for the invoking application to access those errors.

According to exemplary embodiments, an authenticated, reliable, and secure network is provided on top of the HTTP protocol using an XML document type that dynamically transforms itself to define the service specification in a central location, distribute the representation of the service to the service publisher and all subscribing sites and synchronize any changes in the central definition with the local definitions. The XML document carries the inputs of the service to the service application and provides for access to those inputs. The XML document also carries the outputs from the service application to the invoking application and provides for access to those outputs. In addition, the XML document carries any error and debugging output from the service application to the invoking application and provides for access to those errors and debugging outputs.

It should be understood that the foregoing description and accompanying drawings are by example only. A variety of modifications are envisioned that do not depart from the scope and spirit of the invention. This description is intended by way of example only and is not intended to limit the present invention in any way.

What is claimed is:

1. A method for centrally defining and distributing connection definitions over a network, comprising the steps of:
defining a connection, the connection including information identifying an associated service definition, an associated origination endpoint and an associated destination endpoint within the network;
distributing the connection definition via the network to the origination endpoint and the destination endpoint; and
implementing a service defined by the service definition between the origination endpoint and the destination endpoint, whereby the origination endpoint and the destination endpoint communicate with each other directly over the network in a secure and reliable way.

2. The method of claim 1, wherein the service definition includes a service name, associated inputs, and associated outputs.

3. The method of claim 2, wherein each input or output may be a simple value, an XML document, or an arbitrary binary object.

4. The method of claim 1, wherein an endpoint may be used as an origination endpoint, a destination endpoint, or both simultaneously.

5. The method of claim 1, wherein the step of defining a connection includes:
publishing a service definition by a service publisher at the origination endpoint or the destination endpoint;
inviting participation in the connection for implementing the service by a service subscriber at either the destination endpoint or the origination endpoint, respectively; and
accepting the invitation to participate by the service subscriber at either the destination endpoint or the origination endpoint, respectively.

6. The method of claim 1, further comprising the steps of:
updating the connection definition; and
distributing the updated connection definition to the endpoints via the network.

7. The method of claim 6, wherein the step of updating comprises updating the information identifying the origination endpoint, the destination endpoint, or both.

8. The method of claim 6, wherein the step of updating comprises updating the service defined by the service definition.

9. The method of claim 1, further comprising an initial step of distributing management information to at least one endpoint for managing the definition of connections and the distribution of connection definitions, wherein the management information is also distributed to the other endpoint at the same time or at a later time.

10. The method of claim 8, further comprising:
updating the management information; and
distributing the updated management information to the endpoints.

11. An apparatus for centrally defining and distributing connection definitions over a network, comprising:
a database for storing a connection definition, including information identifying an associated service definition, an associated origination endpoint and an associated destination endpoint within the network; and
distribution means for distributing the connection definition via the network to the origination endpoint and the destination endpoint, wherein a service defined by the service definition is implemented by the origination endpoint and the destination endpoint, such that the origination endpoint and the destination endpoint communicate with each other directly over the network.

12. The apparatus of claim 11, wherein the service definition includes a service name, associated inputs, and associated outputs.

13. The apparatus of claim 121, wherein each input or output may be a simple value, an XML document, or an arbitrary binary object.

14. The apparatus of claim 11, wherein an endpoint may be used as an origination endpoint, a destination endpoint, or both simultaneously.

15. The apparatus of claim 11, wherein the apparatus defines a connection definition by storing a service definition published by a service publisher at either the origination endpoint or the destination endpoint, storing information indicating an invitation from the service publisher at the origination endpoint or the destination endpoint for participating in a connection for implementing the service to a service subscriber at either the destination endpoint or the origination endpoint, respectively, and storing information indicating acceptance of the invitation by a service subscriber at either the destination endpoint or the origination endpoint, respectively.

16. The apparatus of claim 11, further comprising means for updating the connection definition, wherein the distribution means distributes the updated connection definition to the endpoints.

17. The apparatus of claim 16, wherein the updating means updates the information identifying the origination endpoint, the destination endpoint, or both.

18. The apparatus of claim 16, wherein the updating means updates the service defined by the service definition.

19. The apparatus of claim 11, wherein the distribution means initially distributes management information to at least one endpoint for managing the definition of connections and the distribution of connection definitions, and the distribution means also distributes the management information to the other endpoint at the same time or at a later time.

20. The apparatus of claim 18, further comprising means for updating the management information, wherein the distribution means distributes the updated management information to the endpoints.

21. A system for centrally defining and distributing connection definitions over a network, comprising:
an origination endpoint;
a destination endpoint; and
a central server connected via the network to the origination endpoint and the destination endpoint for storing a connection definition including information identifying an associated service definition, the origination endpoint and the destination endpoint within the network and for distributing the connection definition via the network to the origination endpoint and the destination endpoint, wherein a service defined by the service definition is implemented by the origination endpoint and the destination endpoint such that the origination endpoint and the destination endpoint communicate with each other directly over the network.

22. The system of claim 21, wherein the service definition includes a service name, associated inputs, and associated outputs.

23. The system of claim 22, wherein each input or output may be a simple value, an XML document, or an arbitrary binary object.

24. The system of claim 21, wherein an endpoint may be used as an origination endpoint, a destination endpoint, or both simultaneously.

25. The system of claim 21, wherein for defining a connection, a service publisher at either the origination endpoint or the destination endpoint publishes a service definition at the central server and invites the a service subscriber at the other endpoint to participate in the connection to implement the service, and the service subscriber at the other endpoint accepts the invitation to participate.

26. The system of claim 21, wherein the central server updates the connection definition and distributes the updated connection definition to the endpoints.

27. The system of claim 26, wherein the central server updates the information identifying the origination endpoint, the destination endpoint, or both.

28. The system of claim 26, wherein the central server updates the service defined by the service definition.

29. The system of claim 21, wherein the central server initially distributes management information to at least one endpoint for managing the definition of connections and the distribution of connection definitions, and the central server also distributes the management information to the other endpoint at the same time or at a later time.

30. The system of claim 28, wherein the central server updates the management information and distributes the updated management information to the endpoints.
